(19) United States
(12) Patent Application Publication
(10) Pub. No.: US 2016/0139269 A1
(43) Pub. Date: May 19, 2016

(54) ELEVATOR SHAFT INTERNAL CONFIGURATION MEASURING DEVICE, ELEVATOR SHAFT INTERNAL CONFIGURATION MEASUREMENT METHOD, AND NON-TRANSITORY RECORDING MEDIUM

(71) Applicant: KABUSHIKI KAISHA TOSHIBA, Tokyo (JP)

(72) Inventors: Masaki YAMAZAKI, Tokyo (JP); Akihito SEKI, Kanagawa (JP); Norihiro NAKAMURA, Kanagawa (JP)

(21) Appl. No.: 14/943,323

(22) Filed: Nov. 17, 2015

(30) Foreign Application Priority Data
Nov. 19, 2014 (JP) 2014-235008

(51) Int. Cl. G01S 17/88; G01S 17/08

(52) U.S. Cl. CPC G01S 17/88; G01S 17/08

(57) ABSTRACT

According to one embodiment, an elevator shaft internal configuration measuring device includes a position calculator and a calculating unit. The position calculator derives a positional information of a moving object moving through an interior of an elevator shaft having an inner side. The calculating unit calculates a configuration of the elevator shaft based on an operation information, a distance data, and the positional information. The operation information relates to an operation of a holder holding a laser rangefinder mounted to the moving object. The distance data is obtained from the laser rangefinder. The operation includes switching between a first state and a second state based on the positional information. The laser rangefinder irradiates the laser light onto a first region of the inner side in the first state. The laser rangefinder irradiates the laser light onto a second region of the inner side in the second state.

### CROSS-REFERENCE TO RELATED APPLICATIONS

This application is based upon and claims the benefit of priority from Japanese Patent Application No. 2014-235008, filed on Nov. 19, 2014; the entire contents of which are incorporated herein by reference.

### FIELD

Embodiments described herein relate generally to an elevator shaft internal configuration measuring device, an elevator shaft internal configuration measurement method and a non-transitory recording medium.

### BACKGROUND

In the preparation stages when performing the replacement or repair of an elevator, work is performed to ascertain conditions inside the elevator shaft and measure the dimensions of the parts inside the elevator shaft necessary to make drawings. It is desirable to measure the configuration of the parts of the elevator shaft with high precision.

### BRIEF DESCRIPTION OF THE DRAWINGS

FIG. 1 is a block diagram showing an elevator shaft internal configuration measuring device according to the embodiment;

FIG. 2 is a flowchart showing the elevator shaft internal configuration measurement method according to the embodiment;

FIG. 3 is a schematic view showing the elevator shaft internal configuration measuring device according to the embodiment;

FIG. 4 is a schematic view showing the elevator shaft internal configuration measuring device according to the embodiment;

FIG. 5A and FIG. 5B are schematic views showing the estimation of the movement of the imaging device;

FIG. 6A and FIG. 6B are schematic views showing an operation of the elevator shaft internal configuration measuring device according to the embodiment;

FIG. 7A to FIG. 7C are schematic views showing an operation of the elevator shaft internal configuration measuring device according to the embodiment;

FIG. 8 is a schematic view showing the rotation of the rotating platform according to the embodiment; and

FIG. 9 is a schematic view showing the rotation of the rotating platform according to the embodiment.

### DETAILED DESCRIPTION

According to one embodiment, an elevator shaft internal configuration measuring device includes a position calculator and a calculating unit. The position calculator derives a positional information corresponding to a position of a moving object moving through an interior of an elevator shaft. The elevator shaft has an inner side. The calculating unit calculates a configuration of the elevator shaft based on an operation information, a distance data between the inner side and a laser rangefinder, and the positional information. The operation information relates to an operation of a holder holding the laser rangefinder. The holder changes an irradiation direction of laser light. The laser light is irradiated from the laser rangefinder onto the inner side. The laser rangefinder is mounted to the moving object. The distance data is obtained from the laser rangefinder. The operation includes switching between a first state and a second state based on the positional information. The laser rangefinder irradiates the laser light onto a first region of the inner side in the first state. The laser rangefinder irradiates the laser light onto a second region of the inner side in the second state.

According to another embodiment, an elevator shaft internal configuration measurement method includes deriving a positional information corresponding to a position of a moving object moving through an interior of an elevator shaft. The elevator shaft has an inner side. The method includes calculating a configuration of the elevator shaft based on an operation information, a distance data between the inner side and a laser range finder, and the positional information. The operation information relates to an operation of a holder holding the laser rangefinder. The holder changes an irradiation direction of laser light. The laser light is irradiated from the laser rangefinder onto the inner side. The laser rangefinder is mounted to the moving object. The distance data is obtained from the laser rangefinder. The operation includes switching between a first state and a second state based on the positional information. The laser rangefinder irradiates the laser light onto a first region of the inner side in the first state. The laser rangefinder irradiates the laser light onto a second region of the inner side in the second state.

According to another embodiment, a non-transitory recording medium records an elevator shaft internal configuration measurement program. The program causes a computer to execute, processing of deriving a positional information corresponding to a position of a moving object moving through an interior of an elevator shaft. The elevator shaft has an inner side. The program causes a computer to execute, processing of calculating a configuration of the elevator shaft based on an operation information, a distance data between the inner side and a laser rangefinder, and the positional information. The operation information relates to an operation of a holder holding the laser rangefinder. The holder changes an irradiation direction of laser light. The laser light is irradiated from the laser rangefinder onto the inner side. The laser rangefinder is mounted to the moving object. The distance data is obtained from the laser rangefinder. The operation includes switching between a first state and a second state based on the positional information. The laser rangefinder irradiates the laser light onto a first region of the inner side in the first state. The laser rangefinder irradiates the laser light onto a second region of the inner side in the second state.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

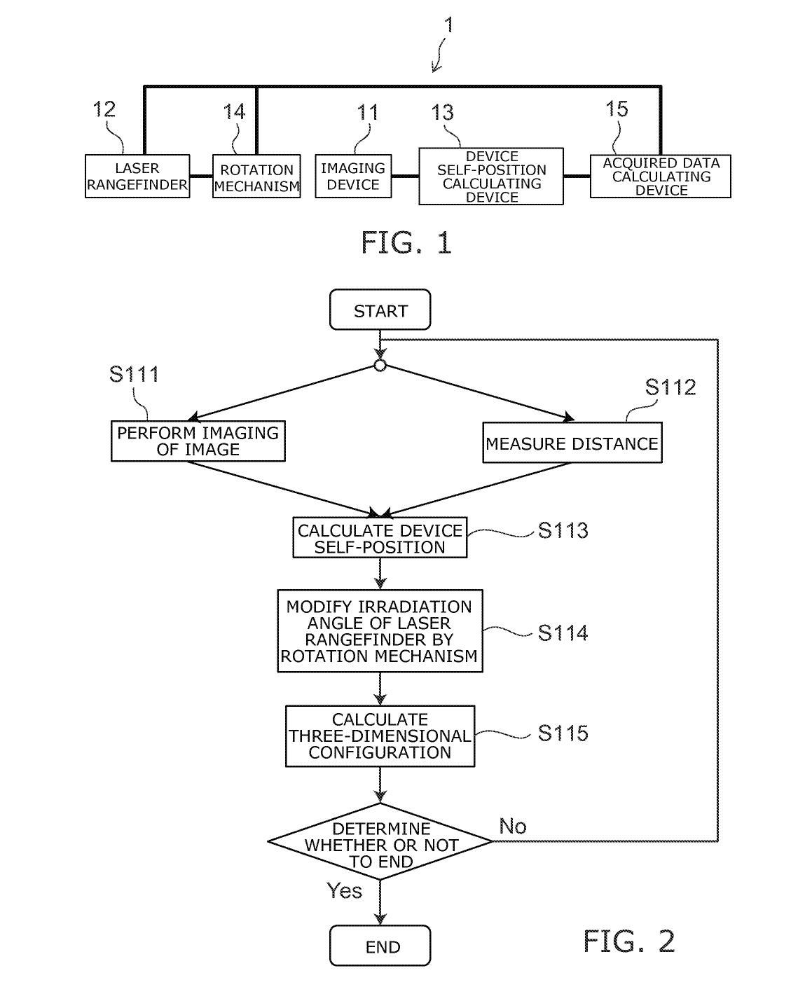

FIG. 1 is a block diagram illustrating an elevator shaft internal configuration measuring device according to the embodiment.

FIG. 2 is a flowchart illustrating the elevator shaft internal configuration measurement method according to the embodiment.

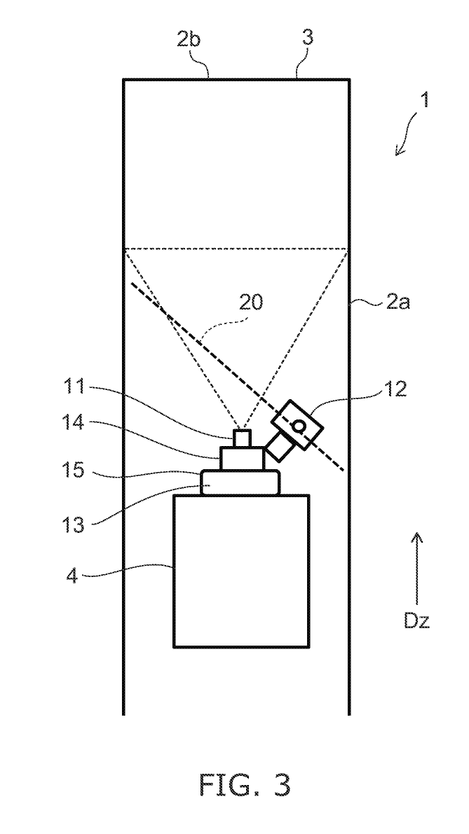

FIG. 3 is a schematic view illustrating the elevator shaft internal configuration measuring device according to the embodiment.

As shown in FIG. 1, the elevator shaft internal configuration measuring device 1 according to the embodiment includes a position calculator (a device self-position calculating device) 13 and a calculating unit (an acquired data calculating device) 15.

In the example, the elevator shaft internal configuration measuring device 1 further includes a laser rangefinder 12, a holder (a rotation mechanism) 14, and an imaging device 11.

As shown in FIG. 3, the elevator shaft internal configuration measuring device 1 is mounted to a moving object 4 that moves through the interior of a shaft 3. The moving object 4 is an elevator car that moves through the shaft 3 along a direction Dz in which the shaft 3 extends. The shaft 3 has an inner side (inner surface) including a side surface 2a and a ceiling 2b. The side surface 2a (a first region) is a surface along the direction Dz; and the ceiling 2b (a second region) is a surface intersecting the direction Dz.

The imaging device 11 is provided on the moving object 4. The imaging device 11 is, for example, a stereo camera. The stereo camera includes two digital cameras. The digital camera is, for example, a digital camera that can receive visible light or a digital camera that can receive infrared light. A portion of the imaging range of one digital camera and a portion of the imaging range of the other digital camera overlap each other. The imaging device 11 may be a camera that images a constant range of angles of view, or an omni-directional camera that can image in all directions (a range in 360 degrees around the camera).

The imaging device 11 moves through the shaft 3 with the moving object 4 and images the interior of the shaft 3.

The holder 14 holds the laser rangefinder 12 mounted to the moving object 4. The holder 14 includes a rotation unit that includes a rotation mechanism; and the rotation unit holds the laser rangefinder 12. For example, the rotation unit is a rotating platform that is mounted on the moving object 4.

The laser rangefinder 12 is provided on the moving object 4 with the holder 14 interposed. The laser rangefinder 12 irradiates laser light on the inner side (e.g., the side surface 2a) inside the shaft 3 that is imaged by the imaging device 11 and measures the reflected light of the irradiated laser light. Thereby, the laser rangefinder 12 measures the distance between the laser rangefinder 12 and a region inside the shaft 3 where the laser light is irradiated. The laser rangefinder 12 measures the distances to multiple regions (multiple measurement points) inside the shaft 3 while moving with the moving object 4.

For example, a time difference-type laser rangefinder or a phase difference-type laser rangefinder is used as the laser rangefinder 12. The time difference-type laser rangefinder calculates the distance between the laser rangefinder and the measurement object by measuring the time from when the laser light is irradiated to when the laser light returns to the laser rangefinder itself after being reflected by the measurement object. The phase difference-type laser rangefinder determines the distance between the laser rangefinder and the measurement object by irradiating laser light modulated into a plurality and by performing the determination based on the phase difference of the diffuse reflection component of the laser light that strikes the measurement object and returns to the laser rangefinder itself.

The laser rangefinder 12 is, for example, a horizontal laser. The horizontal laser can irradiate a laser in multiple directions included in a first plane (a laser irradiation plane) in space when the position of the laser rangefinder is fixed. For example, the horizontal laser can irradiate the laser light in a complete circle of 360 degrees in the horizontal direction.

The irradiation direction (the laser irradiation plane) of the laser light is controlled by the holder 14. For example, the irradiation direction (the emission direction) of the laser light is modified according to the rotation of the rotation unit of the holder 14.

In the example, the position calculator 13 and the calculating unit 15 are provided on the moving object 4.

The position calculator 13 estimates the position of the imaging device 11 inside the shaft 3 based on the image obtained from the imaging device 11. The positional information that is calculated by the position calculator 13 may be positional information corresponding to the position of the moving object 4. The position calculator 13 calculates the movement amount (the distance moved) of the moving object 4 and the velocity of the moving object 4 based on the position of the imaging device 11.

The calculating unit 15 calculates the three-dimensional configuration inside the shaft 3 based on the distance data that is obtained from the laser rangefinder 12, based on the operation information (e.g., the rotation angle) relating to the operation of the holder 14, and based on the positional information that is obtained from the position calculator 13. The velocity of the moving object 4 may be further used to calculate the three-dimensional configuration.

The calibration of calculating the focal length of the imaging device 11, etc., the calibration of calculating the positional relationship (the rotation and the translation) between the cameras of the stereo camera, the calibration of calculating the positional relationship (the rotation and the translation) between the imaging device 11 and the laser rangefinder 12, etc., are performed beforehand. The calibration method between the imaging device 11 and the laser rangefinder 12 may be calculated by the method used in the reference document “Reliable Automatic Camera-Laser Calibration (Australasian Conference on Robotics and Automation 2010),” etc.

The position calculator 13 and the calculating unit 15 that are included in the elevator shaft internal configuration measuring device 1 may include calculating devices including a CPU (Central Processing Unit), memory, etc. A portion of the position calculator 13, the entire position calculator 13, a portion of the calculating unit 15, or the entire calculating unit 15 may include an integrated circuit such as LSI (Large Scale Integration), etc., or an IC (Integrated Circuit) chipset. Each block may include an individual circuit; or a circuit in which some or all of the blocks are integrated may be used. The blocks may be provided as one body; or some blocks may be provided separately. Also, for each block, a portion of the block may be provided separately. The integration is not limited to LSI; and a dedicated circuit or a general-purpose processor may be used.

The blocks shown in FIG. 1 may be able to communicate to each other directly or indirectly via a communication network. The communication network is, for example, a network (a cloud) such as a LAN (Local Area Network), the Internet, etc. The block diagram shown in FIG. 1 is an example of the elevator shaft internal configuration measuring device 1 according to the embodiment and does not necessarily match the configuration of the actual program module. The blocks of FIG. 1 may be separate devices and may be mounted separately.

The processing of the elevator shaft internal configuration measuring device 1 according to the embodiment will now be described in detail.

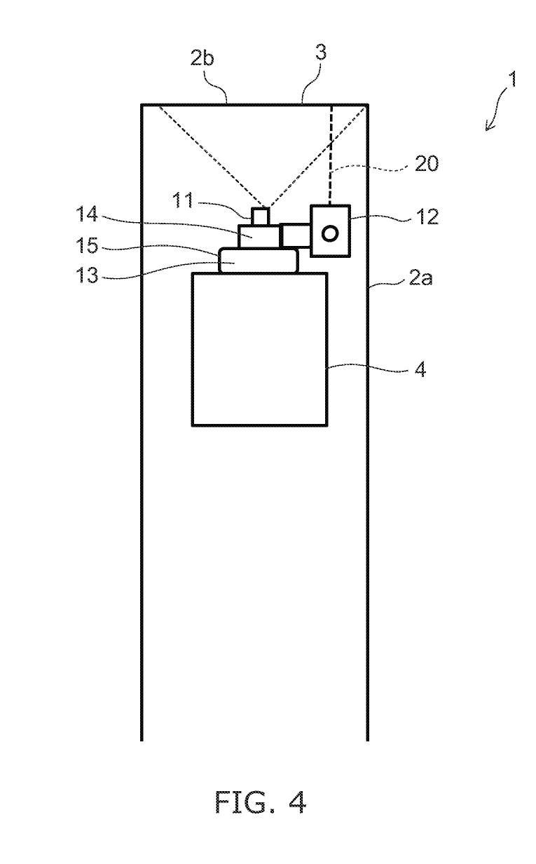

FIG. 4 is a schematic view illustrating the elevator shaft internal configuration measuring device according to the embodiment. FIG. 4 shows the case where the elevator shaft internal configuration measuring device 1 shown in FIG. 3 moves with the moving object 4 and is positioned at the ceiling 2b vicinity.

First, in step S111, the imaging device 11 that is mounted to the moving object 4 acquires an image by imaging the interior of the shaft 3. In the embodiment, although the number of cameras included in the imaging device 11 is a minimum of one, the case is described in the following description where the imaging device 11 is a stereo camera including two cameras. It is desirable for the imaging device 11 to image the interior of the shaft 3 positioned in the travel direction of the moving object 4 as viewed from the imaging device 11. In other words, it is desirable for the imaging device 11 to be mounted facing the travel direction of the moving object 4. The imaging device 11 may not be mounted facing a direction (the horizontal direction) perpendicular to the travel direction of the moving object 4.

For example, as shown in FIG. 3, the imaging device 11 images the side surface 2a and the ceiling 2b positioned higher than the upper portion of the moving object 4 when the elevator shaft internal configuration measuring device 1 is mounted to the upper portion of the moving object 4. As shown in FIG. 4, the imaging device 11 images the ceiling 2b when the moving object 4 moves to the ceiling 2b vicinity.

In step S112, the laser rangefinder 12 irradiates the laser light inside the shaft 3 and measures the distance to the irradiation point (the region where the laser light is irradiated).

The irradiation direction (the irradiation angle) of the laser light is set so that at least a portion of the range where the laser light is irradiated and the imaging range of the image that is imaged in step S111 overlap. For example, distortion may occur in the image due to the characteristics of the lens of the imaging device 11. The distortion in the region of the image proximal to the center point of the image is small compared to the distortion in the region distal to the center point. Therefore, it is desirable to set the irradiation direction (the irradiation angle) of the laser light so that the projection point where the irradiation point is projected onto the image is proximal to the center point of the image. In other words, it is desirable for the irradiation point of the laser light to be proximal to the center point of the image in the image that is imaged by the imaging device 11. Thereby, the precision of the calibration of calculating the positional relationship (the rotation and the translation) between the imaging device 11 and the laser rangefinder 12 can be increased.

In step S113, the position calculator 13 calculates the position of the moving object 4 (the device itself) based on the image that is imaged in step S111.

First, the position calculator 13 estimates the movement (the rotation and the translation) of the imaging device 11 based on the image data. The position calculator 13 further acquires the true scale based on the positional relationship between the cameras of the stereo camera that is calibrated beforehand. Thereby, the position calculator 13 calculates the position of the imaging device 11 inside the shaft 3.

The processing of calculating the position of the imaging device 11 inside the shaft 3 includes, for example, first and second processing.

The first processing is executed when the image that is imaged by the stereo camera is first input to the position calculator 13 at the start of the processing of calculating the position of the imaging device 11. For example, at a first time, a first image 117a is imaged by one camera (a first camera) of the stereo camera; and a second image 117b is imaged by the other camera (a second camera) of the stereo camera. The two images (the stereo images) are input to the position calculator 13. In the first processing, first, the position calculator 13 detects the feature points from the stereo image and performs a search for the corresponding positions between the stereo images (between the first image and the second image). The “feature point” refers to a characteristic portion inside the image that is imaged by the imaging device 11. Continuing, the positions in three-dimensional space corresponding to the feature points (hereinbelow, called the three-dimensional positions of the feature points) are calculated by the principle of triangulation based on the correspondence of the feature points and the positional relationship between the cameras of the stereo camera calibrated beforehand.

The second processing is executed when the stereo image that is imaged at a time (a position) different from that of the two images of the first processing is input to the position calculator 13 in a state in which the three-dimensional positions of the feature points are known.

For example, at the second time that is different from the first time, a third image 117c is imaged by the one camera; and a fourth image 117d is imaged by the other camera. The stereo image at the second time is input to the position calculator 13. At this time, the movement of the imaging device 11 is estimated based on the positions in the image of the feature points and the three-dimensional positions of the feature points. The position calculator 13 can estimate the position of the moving object 4 inside the shaft 3 at each time by repeatedly performing the second processing.

The first processing and the second processing will now be described further.

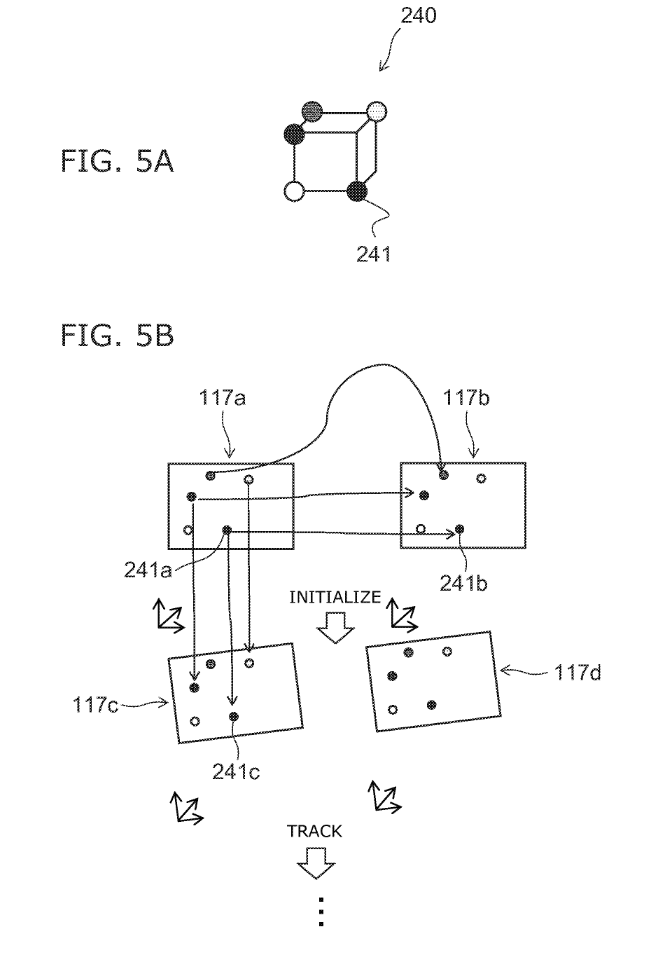

FIG. 5A and FIG. 5B are schematic views illustrating the estimation of the movement of the imaging device.

FIG. 5A is a schematic view showing an object 240 imaged by the imaging device 11. The object 240 includes, for example, a point 241. The point 241 is used as a feature point in the image. For example, the point 241 is a characteristic point of the configuration inside the shaft 3.

In the first processing, the information of the three-dimensional positions of the feature points, the position of the imaging device 11, and the orientation of the imaging device 11 are unknown. Therefore, first, as shown in FIG. 5B, the position calculator 13 performs processing to determine the position of the imaging device 11 and the orientation (the rotation matrix) of the imaging device 11 based on the stereo images (the first image 117a and the second image 117b) at the first time. Here, the position calculator 13 extracts the feature points based on the stereo images that are input.

For example, multiple feature points are extracted from the image. It is desirable for separate feature points not to be extracted within a constant area around one feature point. Thereby, the concentration of the feature points in a portion of the image can be suppressed.

For example, a feature point 241a is a feature point in the first image 117a corresponding to the point 241. A feature point 241b is the position in the second image 117b corresponding to the point 241.

Continuing, a search is performed for the corresponding positions of the feature points between the first image 117a and the second image 117b. The search for the corresponding positions is performed by setting a small region around the feature point and by evaluating the degree of similarity using SSD (Sum of Squared Difference), etc., based on the luminance pattern of the images. Thereby, an association between the feature point 241a of the first image 117a and the feature point 241b of the second image 117b is obtained.

The relative positions and orientations of the two cameras included in the stereo camera are calibrated beforehand. Therefore, the three-dimensional positions of the feature points can be determined based on the positional relationship of the associated feature points in the images and the spatial positional relationship of the cameras. The initial image (the first image 117a) of the first processing matches the global coordinates. The rotation matrix is taken to be the identity matrix; and the translation vector is taken to be the zero vector.

The second processing estimates the position of the imaging device 11 (the moving object 4 inside the shaft 3) and the orientation of the imaging device 11 in the state in which the three-dimensional positions of the feature points are determined by the first processing.

First, the feature points that match the feature points detected by the first processing for the stereo images at the second time are found and associations are obtained (feature point tracking).

For example, a feature point 241c is a feature point in the third image 117c corresponding to the point 241. At this time, the feature point 241c is associated with the feature point 241a or the feature point 241b by the feature point tracking.

In the case where the imaging device 11 has not moved greatly from the previous time (the first time), the feature point tracking may be performed by searching in a range corresponding to the periphery of the feature point found in the image of the previous time. The position calculator 13 estimates the position of the imaging device 11 and the orientation of the imaging device 11 based on the three-dimensional positions of the tracked feature points and the coordinates in the image of the feature points.

The positions in the image of the tracked feature points and the three-dimensional positions of the feature points are projected onto the image based on a rotation matrix R of the first camera (the imaging device 11) and a translation vector t of the first camera. The rotation matrix and the translation vector t are estimated so that the difference between the positions in the image of the tracked feature points and the positions of the three-dimensional positions of the feature points projected onto the image becomes small. The processing is expressed by the following formula.

$$E ( \hat{R} , \hat{t} ) = {min}_{R , t} {\sum }_{i} {( {x}_{i} - P ( R , t ) {X}_{i} )}^{2} \qquad [ Formula 1 ]$$

Here, xᵢ is the position in the image of the ith feature point that was found. P(R, t) is the perspective projection matrix and includes the rotation matrix R and the translation vector t. Xᵢ is the three-dimensional position of the feature point expressed in homogeneous coordinates.

The rotation matrix R and the translation vector t are determined by performing nonlinear optimization to minimize the cost function of Formula (1). Because the movement of the imaging device 11 between adjacent images is not very large, the motion estimation result that is estimated at the previous time can be utilized as the initial value. The scale of the translation vector t that is determined is transformed to true scale based on the positional relationship between the first camera and the second camera calibrated beforehand.

As described above, the position calculator 13 estimates the movement of the imaging device 11 and the position of the imaging device 11 based on the image obtained from the imaging device 11. Thereby, the position calculator 13 calculates the positional information corresponding to the position of the moving object 4 to which the imaging device 11 is mounted.

Although the movement and position of the moving object 4 are calculated based on the image that is imaged by the imaging device 11 in the example, an inertial measurement unit (IMU) such as an acceleration sensor, a gyro, etc., may be used.

In step S114, the holder 14modifies the direction in which the laser rangefinder 12 irradiates the laser light based on the position of the moving object 4 calculated by the position calculator 13.

For example, the holder 14 modifies the angle of the laser rangefinder 12 so that the laser light is irradiated on the ceiling when the moving object 4 approaches the ceiling and stops.

It can be determined that the moving object 4 is stopped in the case where the movement amount (the distance moved) of the moving object 4 is not more than a predetermined threshold (a first threshold) and the velocity of the moving object 4 is not more than a predetermined threshold (a second threshold). For example, the distance from the ground surface to the ceiling inside the shaft 3 is substantially known from the number of floors of the elevator. It can be known that the elevator is stopped at the ceiling vicinity when the ascending or descending elevator car (the moving object 4) stops.

The holder 14 is capable of implementing an operation of switching between a first state ST1 and a second state ST2, where the first state ST1 includes the laser rangefinder 12 irradiating the laser light on the first region (the side surface 2a) inside the shaft 3, and the second state ST 2 includes the laser rangefinder 12 irradiating the laser light on the second region (the ceiling 2b) inside the shaft 3. The holder 14 implements the switching operation recited above when it is determined that the moving object 4 is stopped.

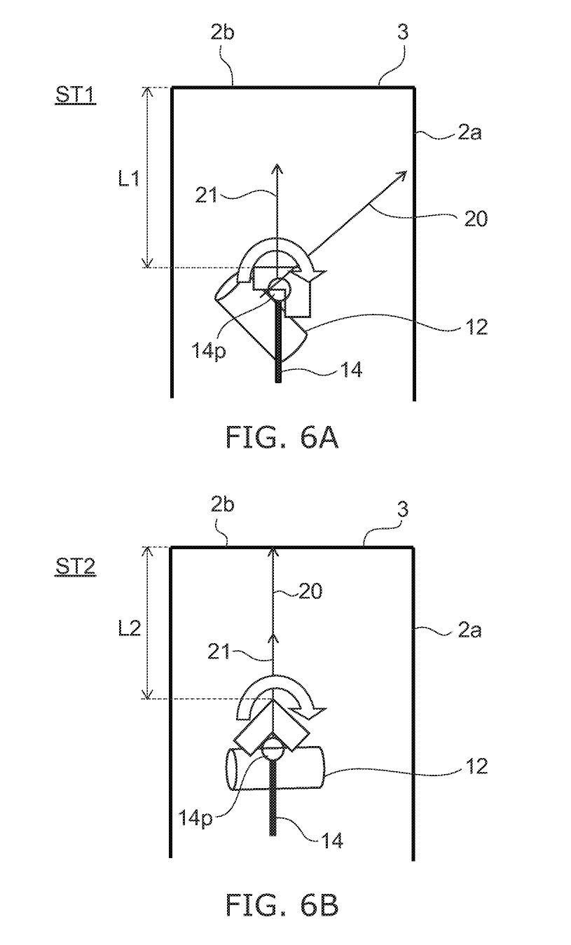

FIG. 6A and FIG. 6B are schematic views illustrating an operation of the elevator shaft internal configuration measuring device according to the embodiment.

FIG. 6A shows the elevator shaft internal configuration measuring device 1 in the first state ST1. FIG. 6B shows the elevator shaft internal configuration measuring device 1 in the second state ST2.

As shown in FIG. 6A and FIG. 6B, the holder 14 includes a rotation unit 14p (a first rotation unit). The laser rangefinder 12 is held by the rotation unit 14p.

A distance L2 between the ceiling 2b and the laser rangefinder 12 in the second state ST2 is shorter than a distance L1 between the ceiling 2b and the laser rangefinder 12 in the first state ST1. In the first state ST1, the moving object 4 is positioned at a position distal to the ceiling 2b. In the second state ST2, the moving object 4 is stopped at a position proximal to the ceiling 2b.

In the first state ST1 as shown in FIG. 6A, the angle between the travel direction of the laser light (a laser irradiation plane 20) and a travel direction 21 of the moving object 4 is, for example, about 45 degrees. However, the angle may not be about 45 degrees.

When the moving object 4 ascends through the shaft 3 and stops at the ceiling 2b vicinity, the rotation unit 14p of the holder 14 rotates. Thus, the rotation unit 14p rotates based on the positional information calculated by the position calculator 13; thereby, the laser rangefinder 12 rotates; and the first state ST1 and the second state ST2 are switched. In the second state ST2, the angle between the travel direction of the laser light (the laser irradiation plane 20) and the travel direction 21 of the moving object 4 is, for example, about 0 degrees. However, the angle may not be about 0 degrees. Thereby, the laser rangefinder 12 can measure the distance by irradiating the laser light onto the ceiling 2b from the position proximal to the ceiling 2b.

Thus, when the moving object 4 approaches the ceiling 2b inside the shaft 3, the laser rangefinder 12 is rotated and the irradiation angle is modified so that the laser light is irradiated on the ceiling 2b. Thereby, the distance to the ceiling 2b from the position proximal to the ceiling 2b can be measured.

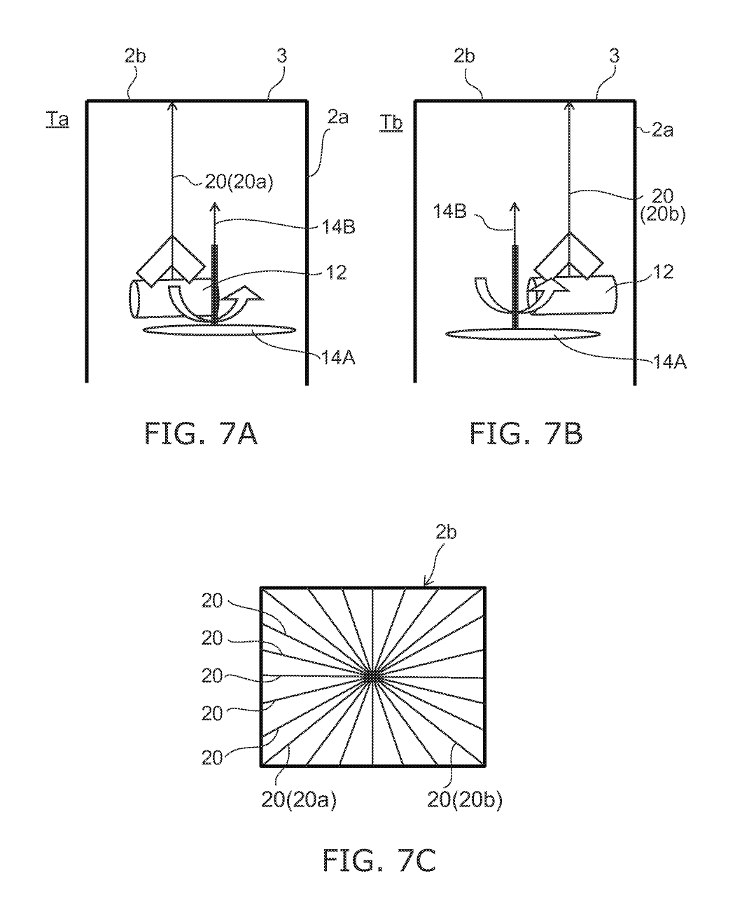

FIG. 7A to FIG. 7C are schematic views illustrating an operation of the elevator shaft internal configuration measuring device according to the embodiment.

FIG. 7A and FIG. 7B show the elevator shaft internal configuration measuring device 1 in the second state ST2.

As shown in FIG. 7A and FIG. 7B, the holder 14 further includes a rotation unit 14A (a second rotation unit). The laser rangefinder 12 is held by the rotation unit 14A. The state of “holding” includes not only the state of holding in direct contact but also the state of holding indirectly with another member interposed.

The rotation unit 14A is, for example, a rotating platform; and the laser rangefinder 12 is mounted on the rotating platform. In the second state ST2 in which the laser light is irradiated on the ceiling 2b, the laser rangefinder 12 is rotated by rotating the rotation unit 14A (hereinbelow, called the rotating platform 14A). In the first state ST1 in which the laser light is irradiated on the side surface 2a, the rotating platform 14A is not rotating.

The rotation axis around which the laser rangefinder 12 rotates is an axis included in the laser irradiation plane 20 (e.g., a rectangular coordinate axis of the optical axis of the laser rangefinder 12, etc.). Thereby, the laser irradiation plane 20 can be rotated.

For example, the rotating platform 14A rotates around an axis intersecting the ceiling 2b. Thereby, the region of the ceiling 2b where the laser light is irradiated changes according to the rotation of the rotating platform 14A. For example, the laser light can be irradiated on the entire region of the ceiling 2b.

FIG. 7A shows the elevator shaft internal configuration measuring device at some time Ta. At this time, a laser irradiation plane 20 a intersects the ceiling 2b.

FIG. 7B shows the elevator shaft internal configuration measuring device at a time Tb that is different from the time Ta.

A laser irradiation plane 20b at the time Tb intersects the ceiling 2b. Because the rotating platform 14A is rotating, the laser irradiation plane 20b at the time Tb is different from the laser irradiation plane 20a at the time Ta.

FIG. 7C shows the laser irradiation plane at multiple times. FIG. 7C shows the ceiling 2b and the laser irradiation plane 20 of the laser light irradiated on the ceiling 2b when the shaft 3 is viewed from above. As shown in FIG. 7C, the laser irradiation plane 20a at the time Ta rotates to the laser irradiation plane 20b at the time Tb. Thus, for example, the entire region of the ceiling 2b can be measured by rotating the laser irradiation plane 20 of a horizontal laser.

The rotating platform 14A is a rotating platform that rotates at a uniform speed, or a rotating platform to which a rotary encoder that can acquire the current rotation angle when rotating is mounted. The rotation angle that is obtained here is used when calculating the three-dimensional configuration in step S115.

By causing a rotation axis 14B of the rotating platform 14A to match the optical axis of the laser rangefinder 12 (the axis included in the laser irradiation plane 20), the calculation of the three-dimensional configuration in step S115 can be simplified.

It is desirable for the rotational speed of the rotating platform 14A to be such that the distance between irradiation points (calculated from the angular resolution/scan time/irradiation angle) of the laser rangefinder 12 is smaller than the pixel resolution of the image that is imaged by the imaging device 11. For example, the rotational speed of the rotating platform 14A is determined so that the density of the multiple measurement points inside the image is higher than the density (the resolution) of the pixels inside the image.

In step S115, the calculating unit 15 calculates the position (the translation vector) and the orientation (the rotation matrix) of the laser rangefinder 12 based on the operation information relating to the operation of the holder 14 and the positional information calculated by the position calculator 13. Then, based on the position and orientation of the laser rangefinder 12, the distance data obtained from the laser rangefinder 12 is converted into the configuration data of the configuration inside the elevator shaft. Here, the operation information relating to the operation of the holder 14 includes at least one of the rotational speed of the rotating platform 14A or the angle (the rotation angle 14E) that the rotating platform 14A rotates.

Specifically, the calculating unit 15 converts the distance data 12A obtained from the laser rangefinder 12 into the distance data 12B of the global coordinate system based on the positional information calculated by the position calculator 13. Then, the converted distance data 12B of the global coordinate system is rotated around the rotation axis 14B of the rotating platform 14A.

In the case where the rotation axis 14B and the optical axis of the laser rangefinder 12 match, the calculating unit 15 rotates the distance data 12B by the amount of the rotation angle 14E of the rotating platform 14A around the optical axis of the laser rangefinder 12.

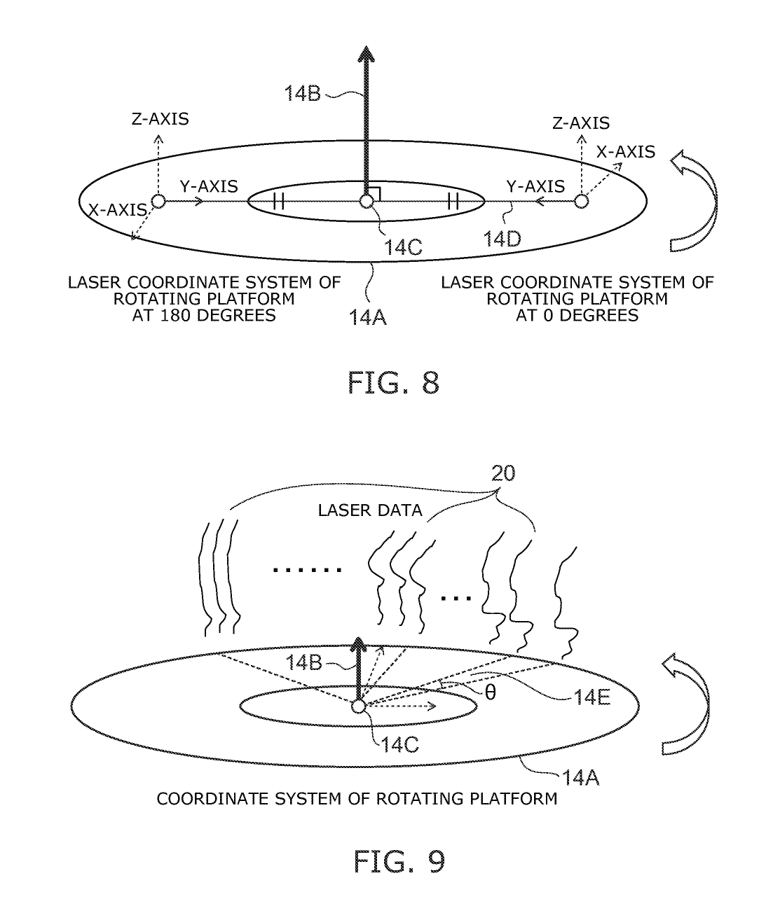

FIG. 8 is a schematic view illustrating the rotation of the rotating platform according to the embodiment. The example shown in FIG. 8 is the case where the rotation axis 14B of the rotating platform 14A does not match the optical axis of the laser rangefinder 12. In such a case, a center coordinate 14C of the rotating platform 14A, a radius 14D of the rotating platform 14A, and the rotation axis 14B of the rotating platform 14A can be determined based on the position and orientation of the laser rangefinder 12 prior to the rotation of the rotating platform 14A (a rotation angle of 0 degrees) and the position and orientation of the laser rangefinder 12 after the rotation of the rotating platform 14A (a rotation angle of 180 degrees).

The center coordinate 14C(X_{t,} Y_{t,} Zₜ) of the rotating platform 14A is the center coordinate between the position of the laser rangefinder 12 prior to the rotation of the rotating platform 14A (the rotation angle of 0 degrees) and the position of the laser rangefinder 12 after the rotation of the rotating platform 14A (the rotation angle of 180 degrees).

The radius 14D(r) of the rotating platform 14A is the length of half of the distance between the position of the laser rangefinder 12 prior to the rotation of the rotating platform 14A (the rotation angle of 0 degrees) and the position of the laser rangefinder 12 after the rotation of the rotating platform 14A (the rotation angle of 180 degrees).

The rotation axis 14B(A_{x,} A_{y,} A_{z}) of the rotating platform 14A is the orientation of the middle (the center) between the orientation of the laser rangefinder 12 prior to the rotation of the rotating platform 14A (the rotation angle of 0 degrees) and the orientation of the laser rangefinder 12 after the rotation of the rotating platform 14A (the rotation angle of 180 degrees).

For example, assuming that the plane in which the laser rangefinder 12 of the rotating platform 14A is mounted is the plane including the X-axis and the Y-axis of the laser coordinate system (the coordinate system having the position of the laser rangefinder 12 as the center), the rotation axis 14B of the rotating platform 14A matches the Z-axis of the laser coordinate system.

FIG. 9 is a schematic view illustrating the rotation of the rotating platform according to the embodiment.

As shown in FIG. 9, the distance data 12B that is obtained from the laser rangefinder 12 in the global coordinate system is rotated by the rotation angle 14E(θ) obtained from the rotating platform 14A. Thus, the three-dimensional configuration inside the shaft 3 can be determined by converting to the same coordinate space.

Specifically, the rotation matrix R(θ) is calculated as follows based on the rotation axis 14B(A_{x,} A_{y,}A_{z}) and the rotation angle 14E(θ) of the rotating platform 14A.

$$R ( θ ) = ( \begin{matrix}{A}_{x}^{2} ( 1 - cos θ ) + cos θ & {A}_{x} {A}_{y} ( 1 - cos θ ) - {A}_{z} sin θ & {A}_{x} {A}_{z} ( 1 - cos θ ) + {A}_{y} sin θ \\ {A}_{x} {A}_{y} ( 1 - cos θ ) + {A}_{z} sin θ & {A}_{y}^{2} ( 1 - cos θ ) + cos θ & {A}_{y} {A}_{z} ( 1 - cos θ ) - {A}_{x} sin θ \\ {A}_{x} {A}_{z} ( 1 - cos θ ) - {A}_{y} sin θ & {A}_{y} {A}_{z} ( 1 - cos θ ) + {A}_{x} sin θ & {A}_{z}^{2} ( 1 - cos θ ) + cos θ\end{matrix} ) \qquad [ Formula 2 ]$$

The translation vector T(θ) is calculated as follows based on the center coordinate 14C(X_{t,} Y_{t,} Zₜ) of the rotating platform 14A and the radius 14D(r) and the rotation angle 14E(θ) of the rotating platform.

$$T ( θ ) = ( \begin{matrix}{X}_{t} \\ {Y}_{t} \\ {Z}_{t}\end{matrix} ) + ( \begin{matrix}r cos θ \\ r sin θ \\ 0\end{matrix} ) \qquad [ Formula 3 ]$$

Based on the rotation matrix R(θ) and the translation vector T(θ) that are determined, the three-dimensional configuration can be determined by rotating the configuration by performing a rigid transformation of the distance data 12B obtained from the laser rangefinder 12.

X_{w}(θ) is the three-dimensional coordinate of the distance data converted based on the rotation matrix R(θ) and the translation vector T(θ), where Xₗ(θ) is the three-dimensional coordinate of the distance data 12B obtained from the laser rangefinder 12. At this time, the three-dimensional configuration can be calculated as follows.

X_{w}(θ)=R(θ)Xₗ(θ)+T(θ) [Formula 4]

When the rotating platform 14A is a rotating platform rotating at uniform speed, the rotation angle 14E (θ) can be determined as follows. First, the number of irradiations of the laser light by the laser rangefinder 12 (the number of laser irradiations) is counted between the start and stop of the rotation of the rotating platform 14A. Then, the angle rotated (the rotation angle) between the start and stop of the rotation of the rotating platform 14A is determined. The rotation angle is, for example, 180 degrees. The rotation angle 14E(θ) per laser irradiation can be calculated by dividing the rotation angle by the number of laser irradiations. The three-dimensional configuration inside the shaft can be calculated from Formulas (2), (3), and (4) using the rotation angle 14E(θ) that is determined.

The three-dimensional configuration inside the elevator shaft may include not only the configuration of the wall surface of the elevator shaft but also the configuration of members mounted inside the shaft. For example, this includes the configuration of the rails mounted to control the travel direction of the elevator car, the configurations of the brackets mounted to the wall surface to support the rails, etc.

The three-dimensional configuration calculation method recited above is a method for measuring the ceiling 2b inside the shaft by rotating the rotating platform 14A. When calculating the three-dimensional configuration of the side surface 2a inside the shaft, the rotation angle 14E(θ) is set to 0 degrees.

For example, when replacing an elevator, a worker performs a site survey by measuring the dimensions inside the shaft of the elevator to be replaced using a tape measure. There are cases where it is difficult to provide sufficient personnel for the site survey. Therefore, it is desirable to measure the dimensions easily in a short amount of time.

Therefore, the configuration around the moving object is measured using the laser rangefinder mounted to the moving object. Thereby, the dimensions can be measured easily in a short amount of time. Here, the position of the moving object can be calculated using an IMU and/or a camera mounted to the moving object. However, in the case where the measurement is performed by irradiating the laser light in a wide range while moving the moving object, the measurement is performed for regions where the distance to the measurement object is long and regions where the distance to the measurement object is short.

When the distance to the measurement object is short, the intensity of the laser light is high; and the precision and density are high for the region where the laser light is irradiated. On the other hand, when the distance to the measurement object is long, the intensity of the laser light is low; and the precision and density are low for the region where the laser light is irradiated. Therefore, in the case where the laser light is irradiated in a wide range while moving the moving object, it is difficult to perform only the measurement where the precision is high. By this method, it is difficult to measure the side surface and the ceiling inside the elevator shaft with high precision by irradiating the laser light from a proximal distance.

Conversely, in the elevator shaft internal configuration measuring device 1 according to the embodiment, the travel direction of the laser light is modified by the rotation unit 14p of the holder 14 when the moving object 4 moves to a position proximal to the ceiling 2b (the second region). In other words, the first state in which the laser light is irradiated on the side surface 2a (the first region) is modified to the second state in which the laser light is irradiated on the ceiling 2b (the second region). Thereby, the measurement distance between the laser rangefinder 12 and the ceiling 2b can be short when measuring the distance to the ceiling 2b.

By using a short measurement distance, the intensity of the laser light can be high. Also, by using a short measurement distance, the irradiation region where the laser light is irradiated can be adjusted with high precision. In other words, high-precision measurement points can be obtained. Further, by using a short measurement distance, the proportion of the ceiling 2b that is the irradiation region where the laser light is irradiated can be increased easily. In other words, the density of the measurement points can be increased. Thereby, the configuration inside the elevator shaft can be measured with high precision.

Thus, the interior of the shaft 3 can be measured with high precision by modifying the irradiation direction of the laser light according to the position of the laser rangefinder 12.

In the case where the angle of the laser light irradiated on the ceiling is fixed in the state in which the laser light is irradiated on the ceiling 2b, the entire region of the ceiling 2b cannot be measured.

Conversely, for the elevator shaft internal configuration measuring device 1 according to the embodiment, the laser rangefinder 12 is held by the rotating platform 14A of the holder 14. The region where the laser light is irradiated on the ceiling 2b can be changed by rotating the rotating platform 14A. Thereby, for example, the entire region of the ceiling 2b can be measured.

A method for measuring the wide region of the ceiling 2b may be considered in which the travel direction of the laser light is changed by using a mirror rotating with respect to the laser irradiation surface. However, in such a case, the apparatus configuration is complex.

The rotational speed of the rotating platform 14A is determined so that the density of the multiple measurement points inside the image that is imaged by the imaging device 11 is higher than the resolution of the image. Thereby, the laser light that is irradiated can correspond to each pixel of the image that is imaged. For example, the dimensions can be measured with high precision by utilizing an image in which the image that is imaged by the imaging device 11 and the three-dimensional configuration calculated by the calculating unit 15 are superimposed.

In the case described above, the elevator shaft internal configuration measuring device 1 is mounted on the elevator car; and the side surface and the ceiling inside the shaft 3 are measured. However, the mounting in the embodiment is not limited to being on the elevator car; and, for example, the elevator shaft internal configuration measuring device 1 may be mounted under the elevator car. Thereby, the floor inside the shaft 3 can be measured with high precision. In the case where the ground surface of the shaft 3 is measured, the elevator shaft internal configuration measuring device 1 is mounted by being placed on the floor surface. It is possible to measure the floor surface by rotating the laser rangefinder 12 using the rotating platform 14A.

The position calculator and the calculating unit according to the embodiment may include a controller such as a CPU, etc., a memory device such as ROM, RAM, etc., an external memory device such as a HDD (Hard Disk Drive), a SSD (Solid State Drive), etc., a display device such as a display, etc. A general-purpose computer device may be used as hardware. Each block may be realized by software or by hardware.

The elevator shaft internal configuration measuring device and the elevator shaft internal configuration measurement method are described above as embodiments. However, the embodiments may have the form of a program that causes a computer to execute the method described above or the form of a computer-readable recording medium in which the program is recorded.

For example, CD-ROM (-R/-RW), a magneto-optical disk, a HD (hard disk), DVD-ROM (-R/-RW/-RAM), a FD (flexible disk), flash memory, a memory card, a memory stick, other various ROM, RAM, etc., may be used as the recording medium.

According to the embodiments, an elevator shaft internal configuration measuring device, an elevator shaft internal configuration measurement method, and a non-transitory recording medium that can measure the dimensions inside an elevator shaft with high precision can be provided.

Hereinabove, embodiments of the invention are described with reference to specific examples. However, the invention is not limited to these specific examples. For example, one skilled in the art may similarly practice the invention by appropriately selecting specific configurations of components such as the position calculator, the calculating unit, the holder, the rotation unit, the imaging device, the laser rangefinder, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all elevator shaft internal configuration measuring devices, all elevator shaft internal configuration measurement methods, and all non-transitory recording mediums practicable by an appropriate design modification by one skilled in the art based on the elevator shaft internal configuration measuring devices, the elevator shaft internal configuration measurement methods, and the non-transitory recording mediums described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An elevator shaft internal configuration measuring device, comprising:
a position calculator deriving a positional information corresponding to a position of a moving object moving through an interior of an elevator shaft, the elevator shaft having an inner side; and
a calculating unit calculating a configuration of the elevator shaft based on an operation information, a distance data between the inner side and a laser rangefinder, and the positional information, the operation information relating to an operation of a holder holding the laser rangefinder, the holder changing an irradiation direction of a laser light, the laser light being irradiated from the laser rangefinder onto the inner side, the laser rangefinder being mounted to the moving object, the distance data being obtained from the laser rangefinder,
the operation including switching between a first state and a second state based on the positional information, the laser rangefinder irradiating the laser light onto a first region of the inner side in the first state, the laser rangefinder irradiating the laser light onto a second region of the inner side in the second state.

2. The device according to claim 1, wherein a distance between the laser rangefinder and the second region in the second state is shorter than a distance between the laser rangefinder and the second region in the first state.

3. The device according to claim 1, wherein the calculating unit calculates the configuration of the elevator shaft also based on a velocity of the moving object.

4. The device according to claim 1, wherein the position calculator derives the positional information based on an image obtained from an imaging device imaging the interior of the elevator shaft.

5. The device according to claim 4, wherein the imaging device includes a stereo camera.

6. The device according to claim 4, wherein
the holder includes a rotation unit holding the laser rangefinder, and
the first state and the second state are switched by the rotation unit rotating based on the positional information.

7. The device according to claim 4, wherein
the holder includes a rotation unit holding the laser rangefinder, and
in the second state, a region where the laser light is irradiated inside the second region changes according to a rotation of the rotation unit.

8. The device according to claim 7, wherein
the rotation unit includes a rotating platform rotating around an axis intersecting the second region, and
the operation information includes at least one of a rotational speed of the rotating platform or an angle rotated by the rotating platform.

9. The device according to claim 8, wherein
the laser rangefinder measures distances between the laser rangefinder and each of a plurality of measurement points inside the elevator shaft, and
a density of the plurality of measurement points inside the image is higher than a density of pixels inside the image.

10. The device according to claim 6, wherein at least a portion of a range where the laser light is irradiated and at least a portion of an imaging range of the image overlap.

11. The device according to claim 1, wherein the calculating unit converts, based on the positional information and the operation information, the distance data into configuration data of a three-dimensional configuration inside the elevator shaft.

12. The device according to claim 1, wherein
the position calculator derives, based on the positional information, a velocity of the moving object and a distance the moving object moves, and
the holder switches from the first state to the second state when the distance the moving object moves is not more than a first threshold and when the velocity is not more than a second threshold, the first threshold and the second threshold being predetermined.

13. The device according to claim 1, wherein the moving object is an elevator car moving through the elevator shaft.

14. The device according to claim 1, wherein
the first region is aligned with an extension direction of the elevator shaft, and
the second region intersects the extension direction.

15. The device according to claim 1, wherein
the first region is a side surface inside the elevator shaft, and
the second region is a ceiling inside the elevator shaft.

16. The device according to claim 1, wherein the laser rangefinder irradiates the laser light in a plurality of directions in a plane when a position of the laser rangefinder is fixed.

17. An elevator shaft internal configuration measurement method, comprising:
deriving a positional information corresponding to a position of a moving object moving through an interior of an elevator shaft, the elevator shaft having an inner side; and
calculating a configuration of the elevator shaft based on an operation information, a distance data between the inner side and a laser range finder, and the positional information, the operation information relating to an operation of a holder holding the laser rangefinder, the holder changing an irradiation direction of laser light, the laser light being irradiated from the laser rangefinder onto the inner side, the laser rangefinder being mounted to the moving object, the distance data being obtained from the laser rangefinder,
the operation including switching between a first state and a second state based on the positional information, the laser rangefinder irradiating the laser light onto a first region of the inner side in the first state, the laser range finder irradiating the laser light onto a second region of the inner side in the second state.

18. A non-transitory recording medium,
an elevator shaft internal configuration measurement program being recorded in the non-transitory recording medium,
the elevator shaft internal configuration measurement program causing a computer to execute
processing of deriving a positional information corresponding to a position of a moving object moving through an interior of an elevator shaft, the elevator shaft having an inner side, and
processing of calculating a configuration of the elevator shaft based on an operation information, a distance data between the inner side and a laser rangefinder, and the positional information, the operation information relating to an operation of a holder holding the laser rangefinder the holder changing an irradiation direction of laser light, the laser light being irradiated from the laser rangefinder onto the inner side, the laser rangefinder being mounted to the moving object, the distance data being obtained from the laser rangefinder,
the operation including switching between a first state and a second state based on the positional information, the laser rangefinder irradiating the laser light onto a first region of the inner side in the first state, the laser rangefinder irradiating the laser light onto a second region of the inner side in the second state.
